(19) United States
(12) Patent Application Publication
(10) Pub. No.: US 2004/0080823 A1
(43) Pub. Date: Apr. 29, 2004

(54) Optical element

(75) Inventors: Michiko Takushima, Yokohama-shi (JP); Tomomi Sano, Yokohama-shi (JP); Makoto Katayama, Yokohama-shi (JP); Masakazu Shigehara, Yokohama-shi (JP)

Correspondence Address: MCDERMOTT WILL & EMERY, 600 13TH STREET, N.W., WASHINGTON, DC, 20005-3096, US

(73) Assignee: Sumitomo Electric Industries, Ltd.

(21) Appl. No.: 10/682,026

(22) Filed: Oct. 10, 2003

Related U.S. Application Data
(60) Provisional application No. 60/462,714, filed on Apr. 15, 2003.

(30) Foreign Application Priority Data
Oct. 10, 2002 (JP) P2002-297638

(51) Int. Cl. G02B 5/30; G02B 27/28

(52) U.S. Cl. 359/483

(57) ABSTRACT

An optical element comprises optical input/output means, polarization separating means, polarization plane rotating means, wavelength branching means, a condenser optical system, and reflecting means. The optical input/output means, for inputting and outputting light, has a plurality of ports. The polarization separating means separates the light into respective polarized light components (first and second light beams) having first and second directions orthogonal to each other. The polarization plane rotating means rotates a polarization direction of the received light beam to make the first and second light beams have the same polarization direction. The wavelength branching means spatially separates the light beams in terms of wavelength, and outputs thus separated wavelength light components. The condenser optical system converges the wavelength light components. The reflecting means has a mirror with a reflecting surface located at a light-converging point of the wavelength light components converged by the condenser optical system. The reflecting means causes the light reflected by the mirror to be outputted from any of the plurality of ports by way of the condenser optical system, wavelength branching means, polarization plane rotating means, and polarization separating means.

### CROSS-REFERENCE TO RELATED APPLICATION

This application claims priority to Provisional Application serial No. 60/462,714 filed on Apr. 15, 2003 which is hereby incorporated by reference in its entirety.

### BACKGROUND OF THE INVENTION

1. Field of the Invention

The present invention relates to an optical element which can multiplex or demultiplex multiwavelength signal light.

2. Related Background Art

Diffraction grating devices act as so-called wavelength branching means. When multiplexed multiwavelength signal light is inputted, a diffraction grating device can cause the multiwavelength signal light to branch off spatially into individual wavelengths. Optical elements using such wavelength branching means can input multiplexed multiwavelength signal light, demultiplex it into individual wavelengths or individual bands, and output them; or multiplex respective multiwavelength signal light components inputted for individual wavelengths or individual bands and output thus multiplexed signal light. Thus, the optical elements are used as optical multiplexers, optical demultiplexers, and the like in optical communication systems. However, the wavelength branching efficiency of such wavelength branching means depends on the polarization direction of incident light. Therefore, depending on the polarization direction of incident light, such wavelength branching means may incur a large loss upon demultiplexing or multiplexing, thus exhibiting a polarization-dependent loss.

Hence, it has been known to lower the polarization-dependent loss of an optical element by causing the light incident on the wavelength branching means to have a fixed polarization direction (see FIG. 6 of Document 1: U.S. Pat. No. 6,084,695). In the optical element disclosed in Document 1, light fed into an input port is divided in terms of polarization into two luminous fluxes by a polarization separating device. Then, the polarization direction of one of the luminous fluxes is rotated by 90° by a half-wave plate, so that the two luminous fluxes attain the same polarization direction. Thereafter, the two luminous fluxes are caused to branch off in terms of wavelength by a diffraction grating device, whereas thus obtained individual wavelength light components are reflected by a prism so as to turn back their optical paths. In the optical element, the individual wavelength light components included in the two luminous fluxes whose optical paths are turned back by the prism are combined in terms of polarization by the half-wave plate and polarization separating device by way of the diffraction grating device, and thus combined light is outputted from an output port.

### SUMMARY OF THE INVENTION

In the optical element disclosed in Document 1, however, the incident angle of the light incident on the prism for turning back the optical paths varies depending on wavelengths. Hence, the incoming path directed from the prism to the output port forms an angle with the outgoing path directed from the input port to the prism, whereby the light coupling efficiency with respect to the output port deteriorates. Therefore, this optical element exhibits a large insertion loss.

In order to overcome the problem mentioned above, it is an object of the present invention to provide an optical element which can reduce both the polarization-dependent loss and insertion loss.

An optical element in accordance with the present invention comprises optical input/output means, polarization separating means, polarization plane rotating means, wavelength branching means, a condenser optical system, and reflecting means. The optical input/output means, for inputting and outputting light, has a plurality of ports. The polarization separating means receives light from any of the plurality of ports, separates the light in terms of polarization into respective polarized light components having first and second directions orthogonal to each other, and outputs a first light beam of the polarized light component having the first direction and a second light beam of the polarized light component having the second direction. The polarization plane rotating means receives any of the first and second light beams outputted from the polarization separating means, rotates a polarization direction of the received light beam to make the first and second light beams have the same polarization direction, and outputs thus rotated light beam. The wavelength branching means receives the first and second light beams outputted from the polarization separating means and the polarization plane rotating means, spatially separates the light beams in terms of wavelength, and outputs thus separated wavelength light components. The condenser optical system receives the wavelength light components outputted from the wavelength branching means after wavelength separation, and converges thus received wavelength light components. The reflecting means has a mirror with a reflecting surface located at a light-converging point of the wavelength light components converged by the condenser optical system. The reflecting means causes the light reflected by the mirror to be outputted from any of the plurality of ports by way of the condenser optical system, wavelength branching means, polarization plane rotating means, and polarization separating means.

The optical element can act as an optical demultiplexer or optical multiplexer. When multiplexed signal light is fed into any of a plurality of ports included in the optical input/output means, the polarization separating means separates the multiplexed signal light in terms of polarization into respective polarized light component having first and second directions orthogonal to each other. Then, the first light beam of the polarized light component having the first direction and the second light beam of the polarized light component having the second direction are outputted. The first and second light beams outputted from the polarization separating means are turned into light beams having the same polarization direction by the polarization plane rotating means, and are then fed into the wavelength branching means. The first and second light beams fed into the wavelength branching means are spatially separated in terms of wavelength by the wavelength branching means, and then are outputted. Thus obtained individual wavelength components of signal light are converged by the condenser optical system, and are made incident on and reflected by a mirror included in the reflecting means. Thus reflected individual wavelengths of signal light are outputted from any of the ports after passing the condenser optical system, wavelength branching means, polarization plane rotating means, and polarization separating means. As such, the multiplexed signal light is demultiplexed. When light propagates in the opposite direction, multiwavelength signal light components are multiplexed, and thus multiplexed signal light is outputted.

As explained in the foregoing, the optical element in accordance with the present invention comprises polarization separating means and polarization plane rotating means. Therefore, the light incident on the wavelength branching means can always attain a polarization direction yielding the highest diffraction efficiency in the wavelength branching means. Also, the light is converged on and reflected by the light-converging point on the reflecting surface in a mirror of the reflecting means, which is a turning point of light from the outgoing path to the incoming path, thus passing through the same condenser optical system in the outgoing and incoming paths. Therefore, even when the angle of inclination of the reflecting surface of the mirror varies, the outgoing and incoming paths become parallel to each other between the port and the condenser optical system. As a consequence, regardless of the state of polarization of input light, the optical element lowers the loss upon demultiplexing or multiplexing, and reduces the polarization-dependent loss.

Preferably, the wavelength light components included in each of the first and second light beams, separated in terms of wavelength by the wavelength branching means, and collected by the condenser optical system have the same incident angle with respect to the reflecting surface of the mirror. Preferably, the polarization plane rotating means receives one of the first and second light beams outputted from the polarization separating means, rotates the polarization direction of thus received light beam by 90°, and outputs thus rotated light beam. Preferably, the wavelength branching means has a wavelength branching efficiency depending on the polarization direction of the incident light, whereas the polarization plane rotating means causes the received light beam to attain a polarization direction yielding the highest wavelength branching efficiency in the wavelength branching means. Preferably, the wavelength branching means includes a diffraction grating device. Preferably, the reflecting means includes a plurality of mirrors.

The present invention will become more fully understood from the detailed description given hereinbelow and the accompanying drawings. They are given by way of illustration only, and thus should not be considered limitative of the present invention.

### BRIEF DESCRIPTION OF THE DRAWINGS

FIGS. 1A and 1B are schematic diagrams of the optical element in accordance with an embodiment.

### DETAILED DESCRIPTION OF THE PREFERRED EMBODIMENTS

In the following, embodiments of the present invention will be explained in detail with reference to the accompanying drawings. In the explanation of the drawings, constituents identical to each other will be referred to with numerals identical to each other without repeating their overlapping descriptions.

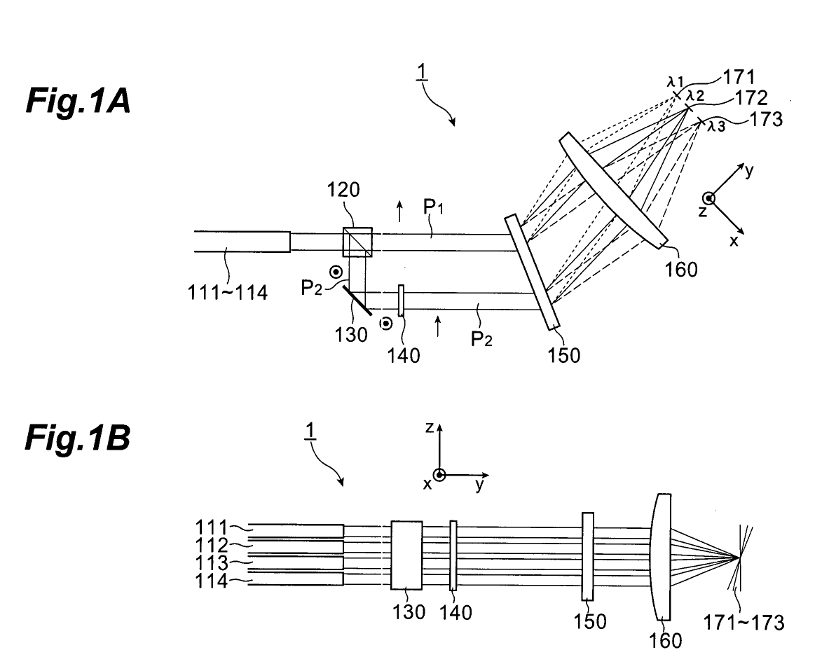

FIGS. 1A and 1B are schematic diagrams of the optical element 1 in accordance with an embodiment. For convenience of explanation, an xyz orthogonal coordinate system is shown in these diagrams. The y axis in the xyz orthogonal coordinate system is parallel to the optical axis of the optical system disposed between input/output ports 111 to 114 and a diffraction grating device 150. Also, the y axis is parallel to the optical axis of an optical system disposed between the diffraction grating device 150 and mirrors 171 to 173. The z axis in the xyz orthogonal coordinate system is common. FIG. 1A is a view of the optical element 1 as seen in the direction parallel to the z axis. FIG. 1B is a view of the optical element 1 as seen in the direction parallel to the x axis. The optical element 1 shown in these diagrams comprises the input/output ports 111 to 114, a polarization beam splitter 120, a mirror 130, a half-wave plate 140, the diffraction grating device 150, a lens 160, and the mirrors 171 to 173.

Each of the input/output ports 111 to 114 constitutes optical input/output means for inputting/outputting light into/from the optical element 1. The respective light inputting/outputting directions of the input/output ports 111 to 114 are located on a first virtual plane (a plane parallel to the yz plane) and are parallel to each other. Namely, when any of the input/output ports 111 to 114 is employed for inputting, the optical axis of light directed from this input/output port to the polarization beam splitter 120 is parallel to the y axis. When any of the input/output ports 111 to 114 is employed for outputting, the optical axis of light directed from the polarization beam splitter 120 to this input/output port is parallel to the y axis as well. The optical axes of the light beams between the respective input/output ports 111 to 114 and the polarization beam splitter 120 are located on the first virtual plane. Preferably, each of the input/output ports 111 to 114 is an optical fiber collimator having a lens function at an end face of an optical fiber.

The polarization bean splitter 120 acts as polarization separating means. Namely, the polarization beam splitter 120 receives light from any of the input/output ports 111 to 114, and separates this light in terms of polarization into respective polarized light components having first and second directions orthogonal to each other. Then, the polarization beam splitter 120 outputs a first light beam of the polarized light component having the first direction to a first optical path P₁, and a second light beam of the polarized light component having the second direction to a second optical path P₂. The first direction is a polarization direction yielding the highest diffraction efficiency in the diffraction grating device 150, and is parallel to the x axis. The second direction is a polarization direction orthogonal to the first direction and parallel to the z axis. Immediately after the first light beam is outputted from the polarization beam splitter 120, the first optical path P₁ is in a direction parallel to the y axis. Immediately after the second light beam is outputted from the polarization beam splitter 120, the second optical path P₂ is parallel to the x axis.

The mirror 130 reflects the second light beam outputted from the polarization beam splitter 120 to the second optical path P₂, and outputs thus reflected second light beam into a direction parallel to the y axis. The half-wave plate 140 receives the second light beam outputted from the mirror 130 to the second optical path P₂, rotates the polarization direction of the second light beam by 90°, and employs the resulting polarization direction as the first polarization direction. The half-wave plate 140 outputs the second light beam having attained the first polarization direction into the second optical path P₂. Namely, the half-wave plate 140 acts as polarization plane rotating means, which can receive any of the first and second light beams outputted from the polarization beam splitter 120, rotate a polarization direction of the received light beam to make the first and second light beams have the same polarization direction, and output thus rotated light beam. In particular, the half-wave plate 140 acting as polarization plane rotating means receives only the second light beam outputted from the polarization beam splitter 120, rotates the polarization direction of the second light beam by 90°, and outputs thus rotated light beam. Also, the half-wave plate 140 acting as polarization plane rotating means causes both the first and second light beams to attain a polarization direction yielding the highest wavelength branching efficiency in the diffraction grating device 150.

The diffraction grating device 150 acts as wavelength branching means. Namely, the diffraction grating device 150 receives the first light beam (polarized light component having the first direction) outputted from the polarization beam splitter 120 to the first optical path P₁, and the second light beam (polarized light component having the first direction) having its polarization direction rotated by 90° by the half-wave plate 140 after being outputted from the polarization beam splitter 120 to the second optical path P₂. The transmission type diffraction grating device 150 diffracts individual wavelength components included in the first and second light beams at respective diffraction angles corresponding to the wavelengths, thereby spatially separating the individual wavelength light components, and output them to the lens 160. The diffraction grating device 150 is disposed such that its grating direction is parallel to the z axis. Therefore, if the optical axis of the light incident on the grating device 150 is parallel to the y axis, the individual wavelength light components outputted from the diffraction grating device 150 after wavelength separation have optical axes located on a second virtual plane (a plane parallel to the xy plane).

The lens 160 constitutes a condenser optical system for converging the individual wavelength light components outputted from the diffraction grating device 150 after wavelength separation. Light-converging points formed by the lens 160 are located on reflecting surfaces of the mirrors 171 to 173. As a consequence, the light is converged onto the reflecting surfaces of the mirrors 171 to 173 by the lens 160. If the lens 160 has no chromatic aberration, respective light converging points for the individual wavelength light components are located on a line parallel to the x axis.

The mirrors 171 to 173 have reflecting surfaces at light-converging points of the wavelength light components converged by the condenser optical system. The mirrors 171 to 173 constitute reflecting means for reflecting the individual wavelength components at the reflecting surfaces. The individual wavelength light components included in each of the first and second light beams converged by the lens 160 after being separated in terms of wavelength by the diffraction grating device 150 have the same incident angle with respect to their corresponding reflecting surfaces of the mirrors. Each of the mirrors 171 to 173 has a reflecting surface whose angle of inclination is set appropriately. As a consequence, each wavelength light component reflected by the reflecting surface is outputted from any of the input/output ports 111 to 114 after passing the lens 160, diffraction grating device 150, half-wave plate 140, mirror 130, and polarization beam splitter 120.

The respective light input/output directions of the input/output ports 111 to 114 are located on the first virtual plane (plane parallel to the yz plane) and are parallel to each other. The individual wavelength light components (in both the first optical path P₁ and second optical path P₂) outputted from the diffraction grating device 150 after wavelength separation have their optical axes located on the second virtual plane (plane parallel to the xy plane). The first and second virtual planes are perpendicular to each other.

Preferably, an optical system is provided between the input/output ports 111 to 114 and the diffraction grating device 150, such that, for the light fed from the input/output ports 111 to 114 to the diffraction grating device 150 (in both the first optical path P₁ and second optical path P₂), the beam width in a direction (parallel to the x axis) parallel to the second virtual plane is greater than the beam width in a direction (parallel to the z axis) perpendicular to the second virtual plane. This can achieve an improved wavelength resolution and a smaller size of the optical element 1.

The line connecting a point at which the optical axis of the first light beam (optical axis of the first optical path P₁) fed from the input/output ports 111 to 114 into the diffraction grating device 150 and a point at which the optical axis of the second light beam (optical axis of the second optical path P₂) fed from the input/output ports 111 to 114 into the diffraction grating device 150 is parallel to the second virtual plane (parallel to the xy plane).

The first and second light beams fed from the side of input/output ports 111 to 114 into the diffraction grating device 150 are inputted to the diffraction grating device 150 in a direction parallel to the y axis and are diffracted by the diffraction grating device 150 at the same diffraction angle. Thus diffracted first and second light beams advance in parallel with each other from the diffraction grating device 150 toward the lens 160, and are converged by the lens 160 onto a common light-converging point on any reflecting surface of the mirrors 171 to 173.

The line connecting a point at which the optical axis of the first light beam fed from the input/output ports 111 to 114 to the diffraction grating device 150 intersects the diffraction grating device 150 and a point at which the optical axis of the second light beam fed from the mirrors 171 to 173 into the diffraction grating device 150 in the incoming path intersects the diffraction grating device 150 is parallel to the z axis and perpendicular to the second virtual plane (plane parallel to the xy plane). Namely, the projection of the outgoing path of the first light beam on the xy plane and the projection of the incoming path of the second light beam on the xy plane coincide with each other. Also, the projection of the outgoing path of the second light beam on the xy plane and the projection of the incoming path of the first light beam on the xy plane coincide with each other.

The mirrors 171 to 173 have respective reflecting surfaces having the same angle of inclination about a line, perpendicular to the second virtual plane, passing the 171 to 173 have respective reflecting surfaces with angles of inclination different from each other about a line (line parallel to the x axis), parallel to the second virtual plane and perpendicular to the optical axis of the second optical system, passing the light-converging point. The angle of inclination of the reflecting surface in each of the mirrors 171 to 173 may be fixed or variable. In the latter case, the respective inclination angles of the reflecting surfaces in the mirrors 171 to 173 are variable about a line (line parallel to the x axis), parallel to the second virtual plane and perpendicular to the optical axis of the second optical system, passing the light-converging point.

While four input/output ports are provided, the inclination angle of each of the reflecting surfaces of the mirrors 171 to 173 is variable in three stages the number of which is smaller than the number of input/output ports by 1. Namely, the inclination angle of the reflecting surface of each mirror is changeable in N stages, and N+1 input/output ports are provided in response thereto. Here, N is an integer of 2 or greater in general, and is 3 in this embodiment. Thus configured optical element 1 can act as an optical demultiplexer or optical multiplexer.

Operations of the optical element 1 will now be explained. In the following explanation, it is assumed that three signal light components having respective wavelengths λ₁ to λ₃ are multiplexed and fed from the input/output port 111, and that the mirrors 171 to 173 reflect the signal light components λ₁ to λ₃, respectively.

The multiplexed signal light components λ₁ to λ₃ fed from the input/output ports 111 are separated in terms of polarization into a first light beam of a polarized light component having a first direction and a second light beam of a polarized light component having a second direction by the polarization beam splitter 120, which are then outputted therefrom. The first light beam of the polarized light component having the first direction outputted from the polarization beam splitter 120 to the first optical path P₁ is made incident on the diffraction grating device 150 as it is. The second light beam of the polarized light component having the second direction outputted from the polarization beam splitter 120 to the second optical path P₂ is reflected by the mirror 130, so as to be converted into the polarized light component having the first direction by the half-wave plate 140, and then made incident on the diffraction grating device 150.

Each of the first and second light beams incident on the diffraction grating device 150 is a polarized light component having the first direction and is made incident on the diffraction grating device 150 in parallel with the y axis. The multiplexed signal light components λ₁ to λ₃ included in each of the first and second light beams incident on the diffraction grating device 150 are diffracted by the diffraction grating device 150 at respective diffraction angles corresponding thereto, so as to be spatially separated in terms of wavelength. The signal light components λ₁ to λ₃ separated in terms of wave length by the diffraction grating device 150 are parallel to each other in each of the first and second light beams, and are converged by the lens 160, so as to be converged onto their corresponding light-converging points on the reflecting surfaces of the mirrors 171 to 173.

The signal light component λ₁ converged by the lens 160 is reflected by the mirror 171 having a reflecting surface at the light-converging point of the signal light component λ₁. The signal light component λ₁ reflected by the mirror 171 diverges immediately after the reflection, but is collimated by the lens 160 and is diffracted by the diffraction grating device 150, since the inclination of the reflecting surface of the mirror 171 is appropriately set. Similarly, the signal light components λ₂, λ₃ converged by the lens 160 are reflected by the mirrors 172, 173 having the reflecting surfaces at their light-converging points, respectively, and diverge immediately after the reflection, but are collimated by the lens 160 and are diffracted by the diffraction grating device 150. In the incoming path, the first and second light beams travel back the second and first optical paths P₂, P₁, respectively.

The first light beam (polarized light component having the first direction) diffracted by the diffraction grating device 150 so as to travel back the second optical path P₂ in the incoming path is converted into a polarized light component having the second direction by the half-wave plate 140 and then is reflected by the mirror 130, so as to be made incident on the polarization beam splitter 120. The second light component (polarized light component having the first direction) diffracted by the diffraction grating device 150 so as to travel back the first optical path P₁ in the incoming path is made incident on the polarization beam splitter 120 as it is. The first and second light beams fed into the polarization beam splitter 120 are combined in terms of polarization by the polarization beam splitter 120. The signal light components λ₁ to λ₃ are outputted from any of the input/output ports 111 to 114.

Which input/output ports 111 to 114 the signal light components λ₁ to λ₃ arrive after traveling the incoming path are determined by the respecting inclination angles of the reflecting surfaces of the mirrors 171 to 173. For example, the signal light components λ₁ to λ₃ can reach the input/output ports 112, 113, 114, respectively, after traveling the incoming path. In this case, the optical element 1 acts as an optical demultiplexer for demultiplexing the inputted multiplexed signal light components λ₁ to λ₃ into the respective wavelengths and outputting thus demultiplexed light components. When the signal light components λ₁ to λ₃ are fed into the input/output ports 112 to 114, respectively, they travel opposite optical paths, and are outputted from the input/output port 111 after multiplexing. In this case, the optical element 1 acts as an optical multiplexer for multiplexing the individually inputted signal light components λ₁ to λ₃ and then outputting thus multiplexed signal light.

For example, the signal light components λ₁, λ₂ having traveled the incoming path can reach the input/output port 113, whereas the signal light component λ₃ having traveled the incoming path can reach the input/output port 114. If the signal light components λ₁, λ₂ are fed into the input/output port 113 whereas the signal light component λ₃ is fed into the input/output port 114, these signal light components travel their opposite optical paths and are outputted from the input/output port 111 after multiplexing. The optical element 1 acts as an optical demultiplexer or optical multiplexer for demultiplexing or multiplexing the signal light components λ₁ to λ₃ in these cases as well.

As in the foregoing, the optical element 1 in accordance with this embodiment comprises the polarization beam splitter 12, mirror 130, and half-wave plate 140. Therefore, the light incident on the diffraction grating device 150 always attains a polarization direction yielding the highest diffraction efficiency in the diffraction grating device 150. The light is converged onto and reflected by the light-converging point on the reflecting surfaces of the mirrors 171 to 173, which is a turning point of the light from the outgoing path to the incoming path, so as to pass the same lens 160 in the outgoing and incoming paths. Therefore, even when the inclination angle of the reflecting surfaces of the mirrors 171 to 173 changes, the outgoing and incoming paths become parallel to each other between the input/output ports 111 to 114 and the lens 160. As a consequence, regardless of the state of polarization of input light, the optical element 1 exhibits a low loss upon demultiplexing or multiplexing, and its polarization-dependent loss is small.

At the turning point from the outgoing path to the incoming path, the light is converged onto and reflected by a mirror. Therefore, the mirror can be made smaller and realized by the MEMS (Micro Electro Mechanism System) technology. The mirrors 171 to 173 are provided for the respective wavelengths of signal light beams to be multiplexed/demultiplexed, whereas the inclination angles of reflecting surfaces of mirrors are variable independently from each other. As a consequence, the optical element 1 can freely select the input and output ports for individual wavelengths of signal light upon demultiplexing or multiplexing. Such reflecting means having a plurality of mirrors with respective reflecting surfaces with variable inclination angles can be realized by the MEMS technology as well.

Without being restricted to the above-mentioned embodiment, the present invention can be modified in various manners.

For example, though the diffraction grating device acting as wavelength branching means is of transmission type in the above-mentioned embodiment, it may be of reflection type. As the wavelength branching means, a photonic crystal may be used in place of the diffraction grating device. When multiplexed multiwavelength signal light is inputted, the photonic crystal can output the individual wavelength components of signal light to optical paths spatially different from each other according to the wavelengths. Therefore, in this regard, the photonic crystal exhibits an action similar to that of the diffraction grating device. The wave number of signal light, the number of input/output ports, and the number of mirrors are not restricted to those explained in the above-mentioned embodiment.

In the above-mentioned embodiment, by using the polarization beam splitter 120 and the mirror 130, two luminous fluxes having respective polarization directions orthogonal to each other are outputted into directions parallel to each other. Here, the polarization beam splitter 120 comprises a couple of rectangular prisms bonded together at an interface coated with a dielectric polarizing film, and outputs two luminous fluxes having respective polarization directions orthogonal to each other into directions orthogonal to each other. Therefore, the mirror 130 is needed for making these two luminous fluxes advance in parallel with each other. However, a birefringent crystal such as rutile, for example, can also be used as the polarization separating means. In this case, two luminous fluxes having respective polarization directions orthogonal to each other are outputted from the birefringent crystal into directions parallel to each other, whereby no mirror is necessary.

As explained in detail in the foregoing, the present invention comprises polarization separating means and polarization plane rotating means. Therefore, the light incident on the wavelength branching means can always attain a polarization direction yielding the highest diffraction efficiency in the wavelength branching means. Also, the light is converged onto and reflected by the light-converging point on a reflecting surface of a mirror of the reflecting means acting as the turning point from the outgoing path to the incoming path, and passes the same condenser optical system in the outgoing and incoming paths. Therefore, even when the angle of inclination of the reflecting surface of the mirror varies, the outgoing and incoming paths become parallel to each other between the input/output port and the condenser optical system. As a consequence, regardless of the state of polarization of input light, the optical element lowers the loss upon demultiplexing or multiplexing, and reduces the polarization-dependent loss.

From the foregoing explanations of the invention, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An optical element comprising:
optical input/output means, having a plurality of ports, for inputting and outputting light;
polarization separating means for receiving light from any of the plurality of ports, separating the light in terms of polarization into respective polarized light components having first and second directions orthogonal to each other, and outputting a first light beam of the polarized light component having the first direction and a second light beam of the polarized light component having the second direction;
polarization plane rotating means for receiving any of the first and second light beams outputted from the polarization separating means, rotating a polarization direction of the received light beam to make the first and second light beams have the same polarization direction, and outputting thus rotated light beam;
wavelength branching means for receiving the first and second light beams outputted from the polarization separating means and the polarization plane rotating means, spatially separating the light beams in terms of wavelength, and outputting thus separated wavelength light components;
a condenser optical system for receiving the wavelength light components outputted from the wavelength branching means after wavelength separation, and converging thus received wavelength light components; and
reflecting means having a mirror with a reflecting surface located at a light-converging point of the wavelength light components converged by the condenser optical system, and causing the light reflected by the mirror to be outputted from any of the plurality of ports by way of the condenser optical system, wavelength branching means, polarization plane rotating means, and polarization separating means.

2. An optical element according to claim 1, wherein the wavelength light components included in each of the first and second light beams, separated in terms of wavelength by the wavelength branching means, and collected by the condenser optical system have the same incident angle with respect to the reflecting surface of the mirror.

3. An optical element according to claim 1, wherein the polarization plane rotating means receives one of the first and second light beams outputted from the polarization separating means, rotates the polarization direction of thus received light beam by 90°, and outputs thus rotated light beam.

4. An optical element according to claim 1, wherein the wavelength branching means has a wavelength branching efficiency depending on the polarization direction of the incident light; and
wherein the polarization plane rotating means causes the received light beam to attain a polarization direction yielding the highest wavelength branching efficiency in the wavelength branching means.

5. An optical element according to claim 1, wherein the wavelength branching means includes a diffraction grating device.

6. An optical element according to claim 1, wherein the wavelength branching means includes a plurality of mirrors.
